(19) United States
(12) Patent Application Publication
(10) Pub. No.: US 2007/0195280 A1
(43) Pub. Date: Aug. 23, 2007

(54) PROJECTOR

(76) Inventors: Chien-Fu Chen, Kweishan (TW); Hung-Yen Huang, Kweishan (TW); Hung-Jen Wei, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/676,324

(22) Filed: Feb. 19, 2007

(30) Foreign Application Priority Data
Feb. 20, 2006 (TW) 095105564

(51) Int. Cl. G03B 21/18; G03B 21/16; G03B 21/26

(52) U.S. Cl. 353/58; 353/61

(57) ABSTRACT

The invention discloses a projector including an optical system, a guiding passage, and two fans. The optical system includes three panels. The guiding passage has three outlets and two inlets. Each outlet of the guiding passage is located opposite to each panel. Each inlet of the guiding passage is located opposite to each fan. Each of the fans directs an air flow into the guiding passage. Thereby, the air flow effectively cools each panel of the optical system.

### BACKGROUND OF THE INVENTION

1. Field of the Invention

This present invention relates to a projector and, more particularly, to a projector capable of effectively cooling the panels of the optical system and the interior of the projector.

2. Description of the Prior Art

Currently, applications of projectors are getting wider and wider. A projector is used not only in common office meetings but also in various academic courses or seminars because it can function as a media player. Generally speaking, a projector has a cooling mechanism, which uses fans to direct an exterior air flow into the interior of the projector, so as to cool the heat produced by the heat sources, such as light-source lamps, panels, and so on.

Referring to FIGS. 1 through 3, FIG. 1 is an external view of a projector 1 according to the prior art. FIG. 2 is the cross section diagram along the X-X line of the projector 1. FIG. 3 is a diagram illustrating an optical system 10 of the projector 1 shown in FIG. 1. As shown in FIG. 1, the projector 1 includes a casing 12 which has an air inlet 120. As shown in FIG. 3, the optical system 10 includes a light-source device 100, a set of liquid crystal display panels 102R, 102G, 102B, and a projection lens 104. Regarding the principle of the mechanism for the optical system 10, please refer to the specification of U.S. Pat. No. 6,976,760, and this will not be further described. As shown in FIGS. 1 through 3, the projector 1 further includes a fan 14 disposed in the interior of the casing 12 and under the projection lens 104. The fan 14 directs an air flow through the air inlet 120 of the casing 12, and it further directs the air flow to the liquid crystal display panels 102R, 102G, 102B via an air intake duct 122, so as to cool the liquid crystal display panels 102R, 102G, 102B. However, according to the above cooling method, after passing through the air intake duct 122, the air flow cannot be concentrated to cool the liquid crystal display panels 102R, 102G, 102B, so the cooling effect is not good. That is, the temperature of the interior of the projector 1 increases because the heat produced by the liquid crystal display panels 102R, 102G, 102B cannot be removed by inefficient cooling. Accordingly, a scope of the invention is to provide a projector to solve the above problems.

### SUMMARY OF THE INVENTION

One scope of the present invention provides a projector, which uses a guiding passage to concentrate the air flow to cool the panels of the optical system, so that the cooling effect is substantially improved. Another scope of the present invention provides a projector, in which a fan is disposed near the projection lens in the interior of the projector, so as to effectively cool the interior of the projector and to avoid a thermal distortion of the image projected by the projection lens. According to a preferred embodiment of the invention, a projector includes an optical system, a guiding passage, and a plurality of first fans. The optical system includes a plurality of panels. The guiding passage has a plurality of outlets and a plurality of inlets, and each of the outlets is located opposite to one of the panels. Each of the first fans is located opposite to one of the inlets of the guiding passage and directs a first air flow into the guiding passage, whereby the guided first air flow effectively cools the panels of the optical system.

In the above preferred embodiment, the optical system further includes a projection lens for projecting an image. The projector further includes a second fan disposed near the projection lens. The second fan directs a second air flow into the interior of the projector and directs the air flow out of the projector, whereby the second air flow effectively cools the interior of the projector and, furthermore, the second fan effectively isolates the heat, so as to avoid a thermal distortion of the image projected by the projection lens.

Therefore, the projector according to the invention can concentrate the air flow by the guiding passage to cool the panels, and it can effectively isolate the heat by disposing the fan near the projection lens, so as to avoid a thermal distortion of the image projected by the projection lens. Thereby, the cooling effect can be substantially improved.

The advantage and spirit of the invention may be understood by the following recitations together with the appended drawings.

### BRIEF DESCRIPTION OF THE APPENDED DRAWINGS

FIG. 1 is an external view of the projector according to the prior art.

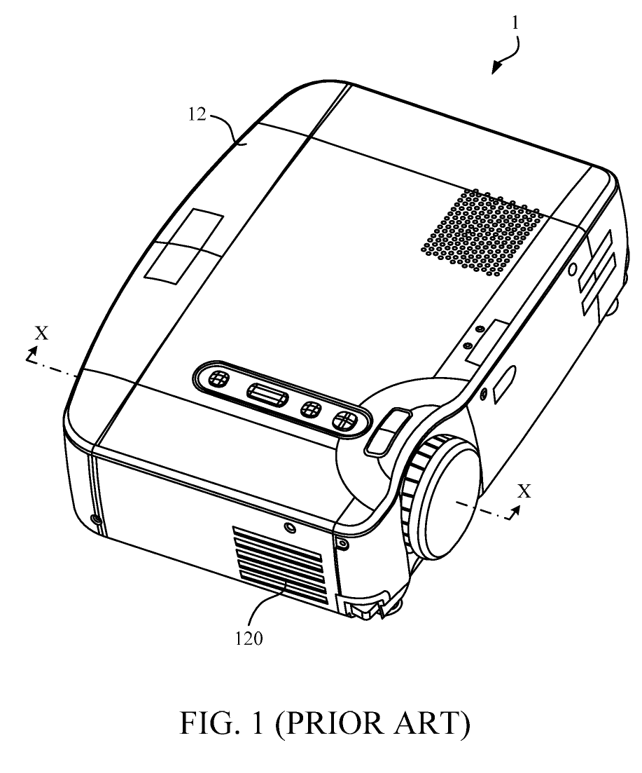

FIG. 2 is the cross section diagram along the X-X line of the projector shown in FIG. 1.

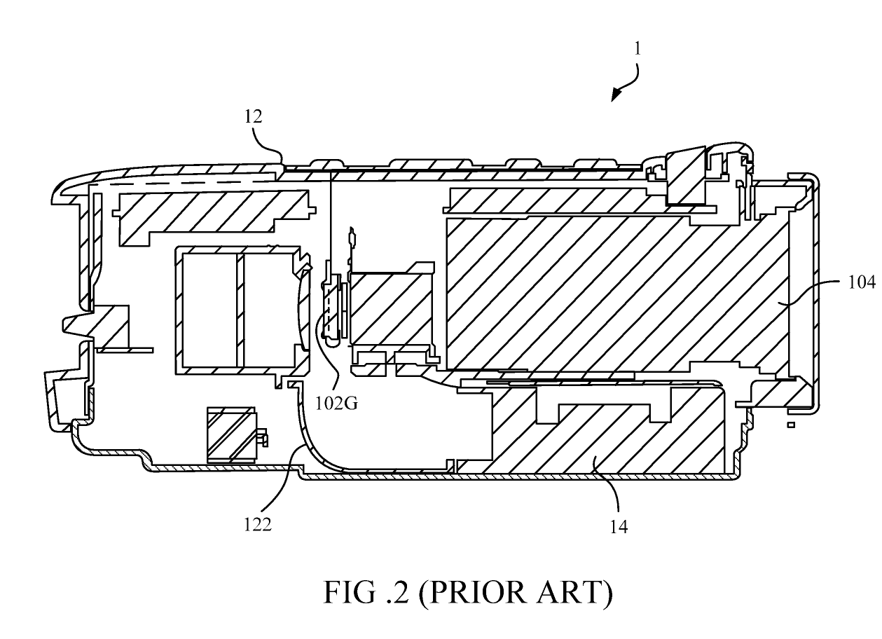

FIG. 3 is a schematic diagram illustrating the optical system of the projector shown in FIG. 1.

FIG. 4 is an exterior view of a projector according to a preferred embodiment of the invention.

FIG. 5 is a bottom view of the projector shown in FIG. 4.

FIG. 6 is an interior view of the projector shown in FIG. 4.

FIG. 7 is an interior view of the projector shown in FIG. 6 without the optical system.

FIG. 8 is a bottom view of the first fans and the guiding passage shown in FIG. 7.

FIG. 9 is a schematic diagram illustrating the optical system shown in FIG. 6.

FIG. 10 is an interior view of the projector without the first fans and the guiding passage shown in FIG. 7.

### DETAILED DESCRIPTION OF THE INVENTION

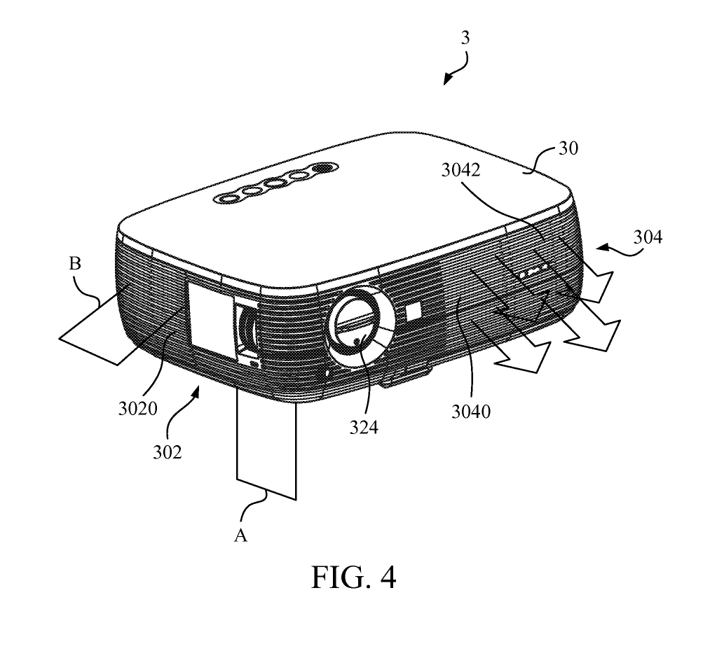

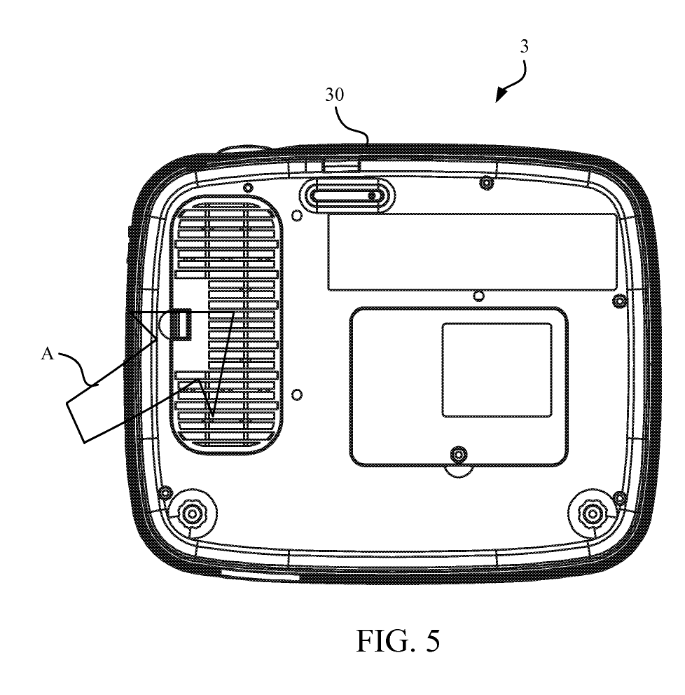

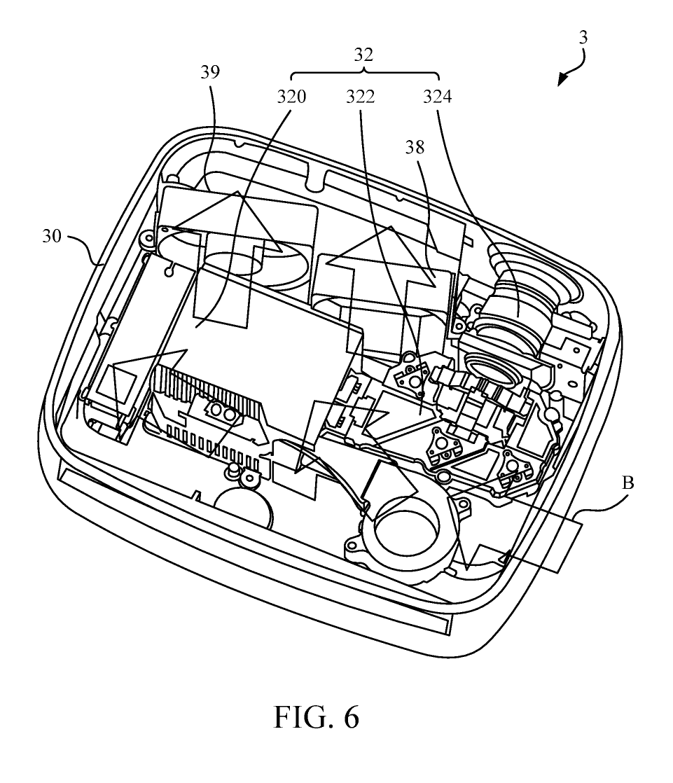

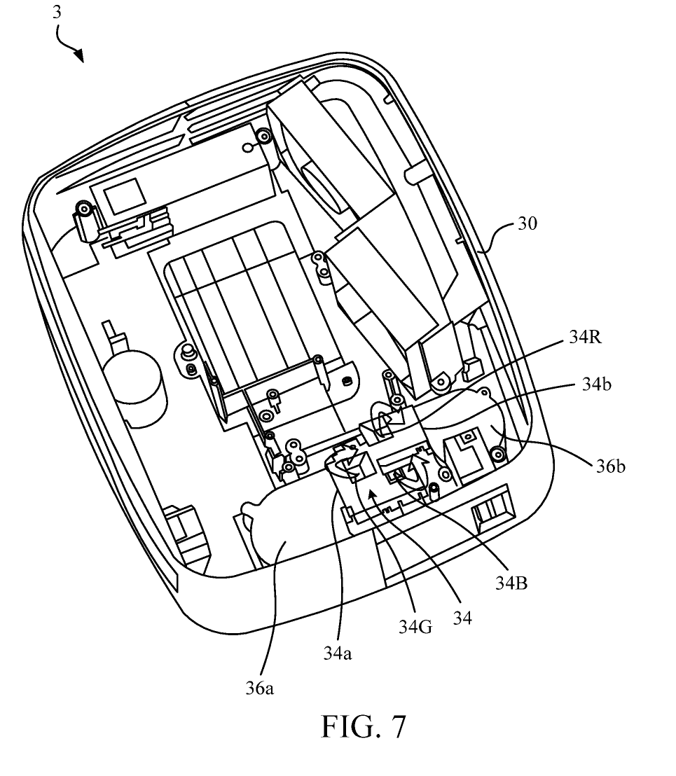

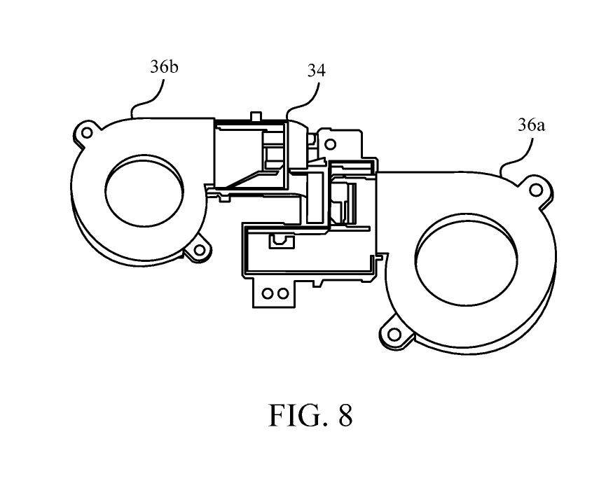

Referring to FIGS. 4 through 8, FIG. 4 is an exterior view of a projector 3 according to a preferred embodiment of the invention. FIG. 5 is a bottom view of the projector 3 shown in FIG. 4. FIG. 6 is an interior view of the projector 3 shown in FIG. 4. FIG. 7 is an interior view of the projector 3 without the optical system 32. FIG. 8 is a bottom view of the first fans 36a, 36b, and the guiding passage 34 shown in FIG. 7. The projector 3 includes a casing 30, an optical system 32, a guiding passage 34, and two first fans 36a, 36b. The casing 30 encapsulates the optical system 32, the guiding passage 34, and the first fans 36a, 36b, as shown in FIG. 6 and FIG. 7. The optical system 32 includes a light-source device 320, an optical module 322, and a projection lens 324.

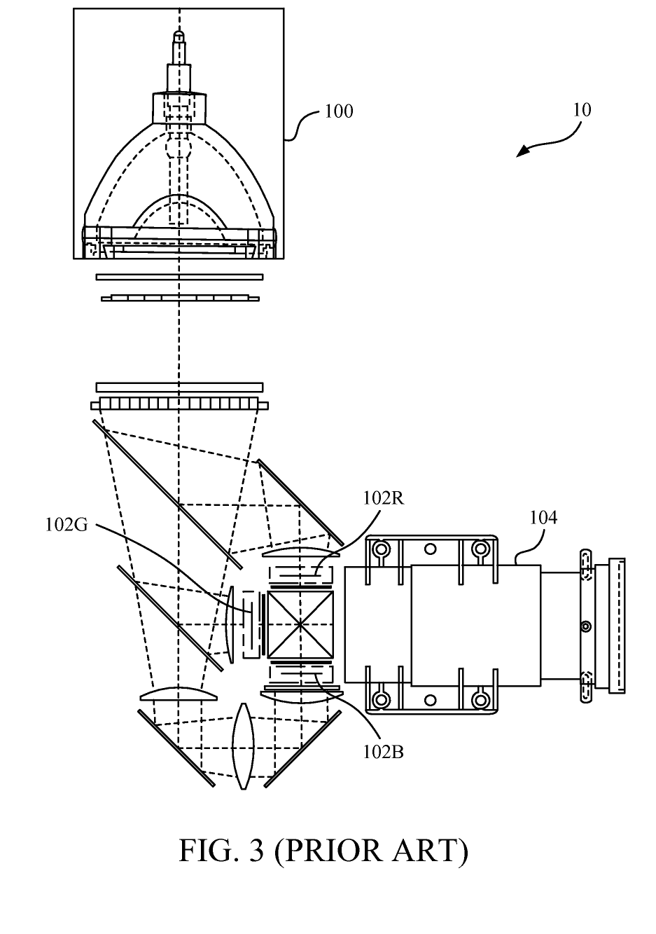

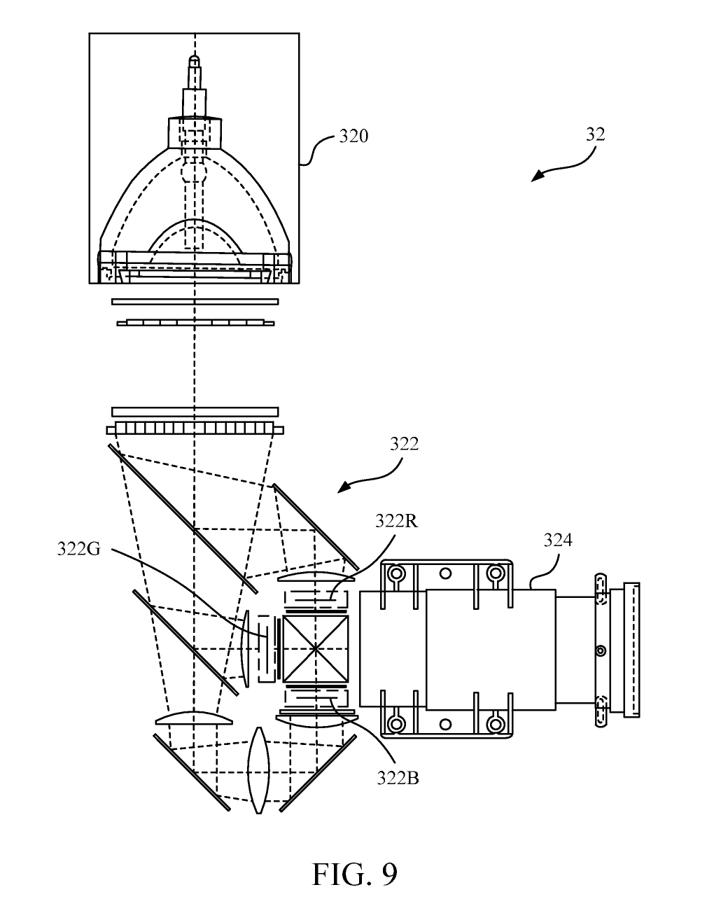

Referring to FIG. 9, FIG. 9 is a diagram illustrating the optical system 32 shown in FIG. 6. The light-source device 320 emits a beam of light, which is processed by the optical module 322 and then is projected to present an image by the projection lens 324. Because the principle of the formation of image for the optical system 32 is same as the one for the optical system 10 shown in FIG. 3, it will not be further described. In this embodiment, the optical module 322 includes liquid crystal display panels 322R, 322G, 322B, as shown in FIG. 9.

Referring to FIG. 7, the guiding passage 34 has three outlets 34R, 34G, 34B and two inlets 34a, 34b. The outlet 34R is located opposite to the liquid crystal display panel 322R, the outlet 34G is located opposite to the liquid crystal display panel 322G, and the outlet 34B is located opposite to the liquid crystal display panel 322B. The first fan 36a is disposed opposite to the inlet 34a of the guiding passage 34, and the first fan 36b is disposed opposite to the inlet 34b of the guiding passage 34.

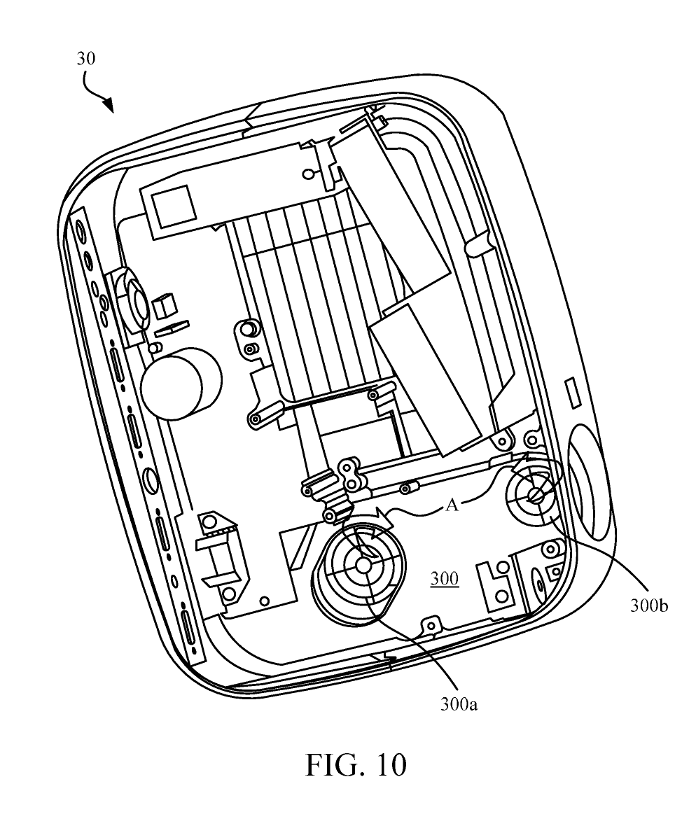

Referring to FIG. 10, FIG. 10 is an interior view of the projector 3 without the first fans 36a, 36b and the guiding passage 34 shown in FIG. 7. The casing 30 has a bottom 300, and first air inlets 300a, 300b are formed on the bottom 300. The first air inlet 300a corresponds with the first fan 36a, and the first air inlet 300b corresponds with the first fan 36b, so that the first fans 36a, 36b respectively direct a first air flow A through the first air inlet 300a, 300b into the guiding passage 34. Then, the first air flow A flows through the outlets 34R, 34G, 34B of the guiding passage 34 respectively to cool the liquid crystal display panels 322R, 322G, 322B. Thereby, the first air flow A effectively cools the liquid crystal display panels 322R, 322G, 322B of the optical system 32.

In the embodiment, the projector 3 further includes a filter located near the first air inlet 300a, 300b for filtering the first air flow A, which is not shown in the FIG. 10.

Referring to FIG. 4 and FIG. 6 again, the projector 3 further includes a second fan 38 and a third fan 39. The second fan 38 is disposed near the projection lens 324 in the casing 30, and the third fan 39 is disposed near the second fan 38 in the casing 30. In this embodiment, the second fan 38 is disposed between the third fan 39 and the projection lens 324, as shown in FIG. 6. The casing 30 further has a first sidewall 302 and a second sidewall 304 as shown in FIG. 4. A second air inlet 3020 is formed on the first sidewall 302, and a first air outlet 3040 and a second air outlet 3042 are formed on the second sidewall 304, wherein the second air outlet 3042 is near the first air outlet 3040, as shown in FIG. 4. The second fan 38 and third fan 39 respectively direct a second air flow B through the second air inlet 3020 into the interior of the projector 3 and direct out the air flow in the projector 3 through the first air outlet 3040 and the second air outlet 3042. Whereby, the second air flow B effectively cools the interior of the projector 3. Furthermore, the third fan 39 mainly directs out the heat in the projector 3, which is mainly produced by lamps. Therefore, the temperature of the air flow ejected through the second air outlet 3042 is higher than that of the air flow ejected through the first air outlet 3040. The second fan 38 is disposed near the projection lens 324 to effectively isolate the hot air flow ejected through the second air outlet 3042, so as to avoid a thermal distortion of the image projected by the projection lens 324.

In the embodiment, the direction of the first air outlet 3040 could be designed to be substantially parallel to that of the second air outlet 3042, depending on actual applications.

In another preferred embodiment, the direction of the first air outlet 3040 could be designed with an included angle ranging from 15 to 30 degrees to the direction of the projection lens 324, so as to further avoid a thermal distortion of the image projected by the projection lens 324.

Comparing with the prior art, the projector according to the invention could concentrate the air flow by the guiding passage to cool the panels, and it could effectively isolate the heat by disposing the fan near the projection lens, so as to avoid a thermal distortion of the image projected by the projection lens. Thereby the cooling effect can be substantially improved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projector, comprising:
an optical system comprising a plurality of panels;
a guiding passage having a plurality of outlets and a plurality of inlets, each of the outlets being located opposite to one of the panels; and
a plurality of first fans, each of the first fans being disposed opposite to one of the inlets, the first fans directing a first air flow into the guiding passage, whereby the first air flow effectively cools the panels of the optical system.

2. The projector of claim 1, further comprising a casing for accommodating the optical system, the guiding passage, and the first fans.

3. The projector of claim 2, wherein the casing has a bottom and a first air inlet, and the first air inlet is formed on the bottom and corresponds to the first fans such that the first fans direct the first air flow through the first air inlet into the guiding passage.

4. The projector of claim 3, further comprising a filter, disposed near the first air inlet, for filtering the first air flow.

5. The projector of claim 2, wherein the optical system further comprises a projection lens for projecting an image.

6. The projector of claim 5, further comprising a second fan, disposed near the projection lens, the casing having a first sidewall and a second sidewall, a second air inlet being formed on the first sidewall, a first air outlet being formed on the second sidewall, the second fan directing a second air flow through the second air inlet into the interior of the projector and directing the second air flow in the interior of the projector through the first air outlet out of the projector.

7. The projector of claim 6, further comprising a third fan for cooling the interior of the projector.

8. The projector of claim 7, wherein a second air outlet is formed on the second sidewall, and the third fan directs the second air flow in the interior of the projector through the second air outlet out of the projector.

9. The projector of claim 8, wherein the temperature of the air flow directed through the second air outlet is higher than the temperature of the air flow directed through the first air outlet.

10. The projector of claim 8, wherein the direction of the first air outlet is substantially parallel to the direction of the second air outlet.

11. The projector of claim 8, wherein an included angle ranging from 15 to 30 degrees is formed between the direction of the first air outlet and the direction of projection of the projection lens.

12. A projector, comprising:
an optical system comprising a projection lens for projecting an image;
a casing, having a first sidewall and a second sidewall, for accommodating the optical system, a second air inlet being formed on the first sidewall, a first air outlet being formed on the second sidewall; and
a second fan, disposed in the interior of the casing near the projection lens, for directing a second air flow through the second air inlet into the interior of the projector and directing the second air flow in the interior of the projector through the first outlet out of the projector, whereby the second air flow effectively cools the interior of the projector, and the second fan effectively isolates heat, so as to avoid a thermal distortion of the image projected by the projection lens.

13. The projector of claim 12, further comprising a third fan, disposed near the second fan, for cooling the interior of the projector.

14. The projector of claim 13, wherein a second air outlet is formed on the second sidewall such that the third fan directs the second air flow in the interior of the projector through the second air outlet out of the projector.

15. The projector of claim 14, wherein the temperature of the air flow directed through the second air outlet is higher than the temperature of the air flow directed through the first air outlet.

16. The projector of claim 15, wherein the second fan is disposed between the third fan and the projection lens.

17. The projector of claim 14, wherein the direction of the first air outlet is substantially parallel to the direction of the second air outlet.

18. The projector of claim 14, wherein an included angle ranging from 15 to 30 degrees is formed between the direction of the first air outlet and the direction of projection of the projection lens.

19. The projector of claim 12, the projector further comprising:
a guiding passage having a plurality of outlets and a plurality of inlets; and
a plurality of first fans, each of the first fans being disposed opposite to one of the inlets, the first fans directing a first air flow into the guiding passage.

20. The projector of claim 19, wherein the casing has a bottom and a first air inlet, and the first air inlet is formed on the bottom and corresponds to the first fans such that the first fans direct the first air flow through the first air inlets into the guiding passage.

21. The projector of claim 20, further comprising a filter, disposed near the first inlets, for filtering the first air flow.
